(19) United States
(12) Patent Application Publication
(10) Pub. No.: US 2008/0239532 A1
(43) Pub. Date: Oct. 2, 2008

(54) Trailer rearview mirror assembly

(76) Inventor: Chun-hsien Wu, Tainan (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/078,201

(22) Filed: Mar. 28, 2008

(30) Foreign Application Priority Data
Apr. 2, 2007 (TW) 096205309

(51) Int. Cl. B60R 1/078

(52) U.S. Cl. 359/872; 359/871

(57) ABSTRACT

A trailer rearview mirror assembly includes a mirror base, a first clipping member and a second clipping member. The mirror base is provided with an elongated support arm. The first clipping member is affixed on the support arm by a first fastener. The second clipping member is coupled to the first clipping member, and provided with a clipping cavity which allows the gripping by a second fastener. Accordingly, the mirror base is therefore handy and stable to affix to the rearview mirror assembly.

### BACKGROUND OF THE INVENTION

1. Field of the Invention

The present invention relates to a rearview mirror assembly for a trailer. More particularly, the present invention relates to one with an affixed auxiliary viewing mirror, which enables the exposure of the blind zones to the vehicle operator during driving.

2. Description of the Prior Art

Due to the loaded freight for a commonly seen truck, trailer, automotive vehicle with a hitched trailer or large vehicle is too protruding, the sizable width and length of these automotive vehicles, and quite a few dead spots for the eyesight; the primary rearview mirror alone fails to present the vehicle operator good backward visibility for a complete surveillance.

An example of such a system is disclosed in Taiwanese Patent No. 1256358 “Fastening device dedicated for auxiliary rearview mirror”, which comprises a buckle and two bands. The buckle is capable of allowing the inner end of the band to insert in it, and capable of adjusting the inserted portion of the band relative to it. The band is provided with a connection element at its external end, which is devised to join with the mated element of the support arm of the auxiliary viewing mirror. Since the buckle device is affixed to the rearview mirror assembly, the auxiliary viewing mirror is provided with a pair of the support arms for the two bands. One band is fixed to the support arm while the other band has its connection element join with the mated element. The apparatus has a numerous composition of components, which is awfully tiresome in the assembly and the production, copes with rising cost, and experiences an easier loosing for the arced buckle at the back of the rearview mirror assembly.

### SUMMARY OF THE INVENTION

The present invention is targeting to settle the problems arising from the numerous components and the easier loosing of the auxiliary rearview mirror and the rearview mirror assembly.

According to the present invention, there is provided a trailer rearview mirror assembly, comprising:

a mirror base, having a support arm extended thereon;

a first clipping member, affixed on said support arm of said mirror base, said first clipping member having a first through hole for insertion of a first fastener; and

a second clipping member, inserted by said first fastener to fix on said first clipping member, said second clipping member having a clipping cavity therein and a second through hole for insertion a second fastener.

Preferably, said mirror base is provided with a reflective mirror.

Preferably, said mirror base is pivotally connected to said support arm.

Preferably, said first through hole is a threaded hole and said first fastener is a screw bolt.

Preferably, the second fastener is a screw bolt and the second fastener is provided with a tightening member.

Preferably, the tightening member is provided with a locating portion.

Preferably, the second clipping member is provided with a limiting slot for insertion of said locating portion of said tightening member.

The present invention has the following advantages:

1. The constituent parts of the present invention are less, which substantially simplifies the assembly and saves time.

2. The second clipping member of the present invention is able to seize the rearview mirror firmly subject to the pressing by the tightening member.

### BRIEF DESCRIPTION OF THE DRAWINGS

FIG. 1 is an exploded view of the present invention;

FIG. 2 is a perspective view of the present invention;

FIG. 3 is a cross-sectional view of the present invention;

FIG. 4 is a perspective view of the present invention coupled to a rearview mirror; and

FIG. 5 is a cross-sectional view of the present invention coupled to the rearview mirror.

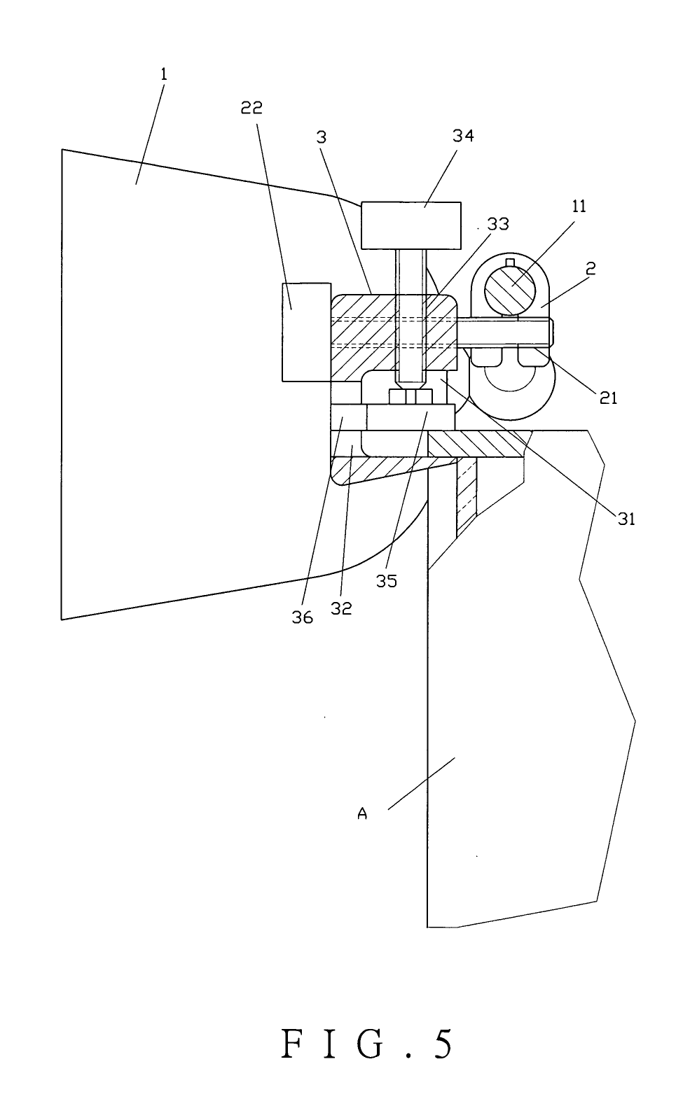

### DETAILED DESCRIPTION OF THE PREFEREED EMBODIMENT

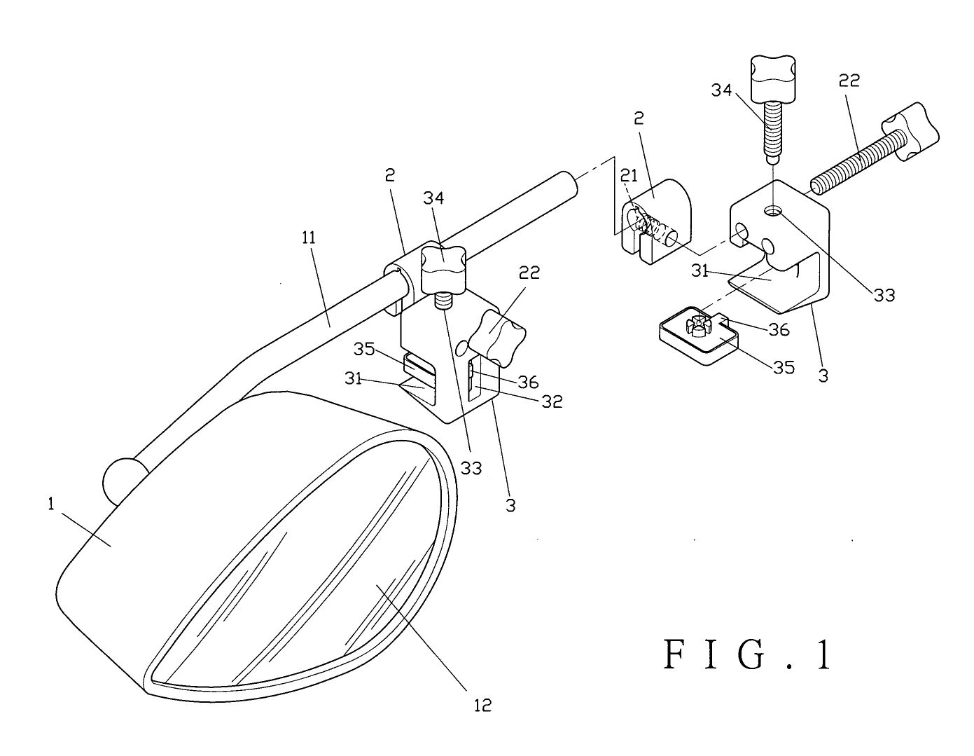

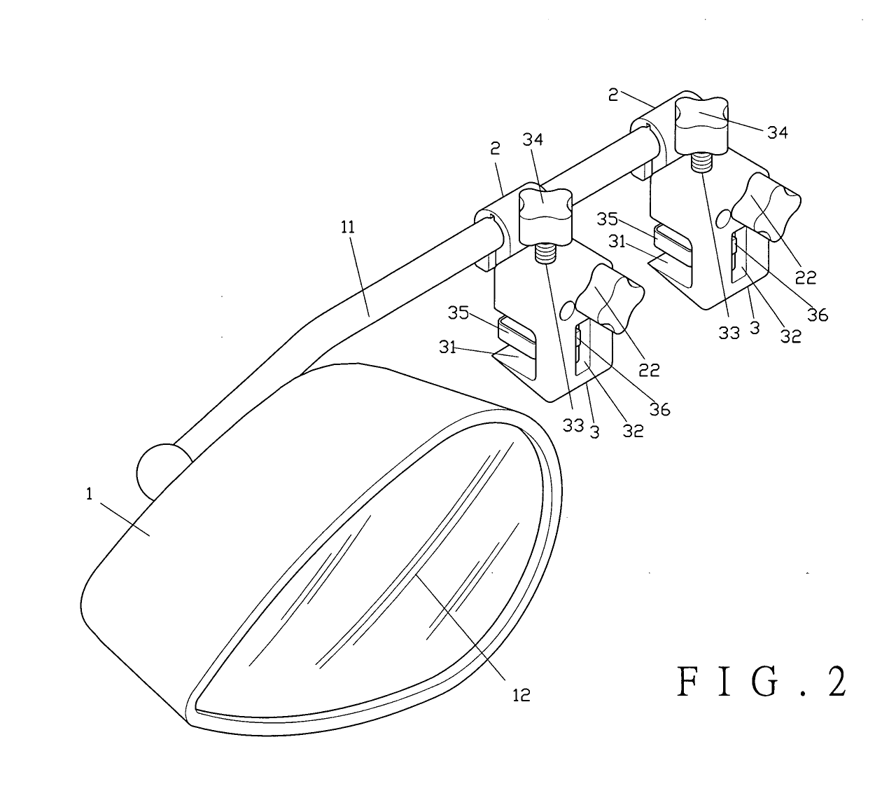

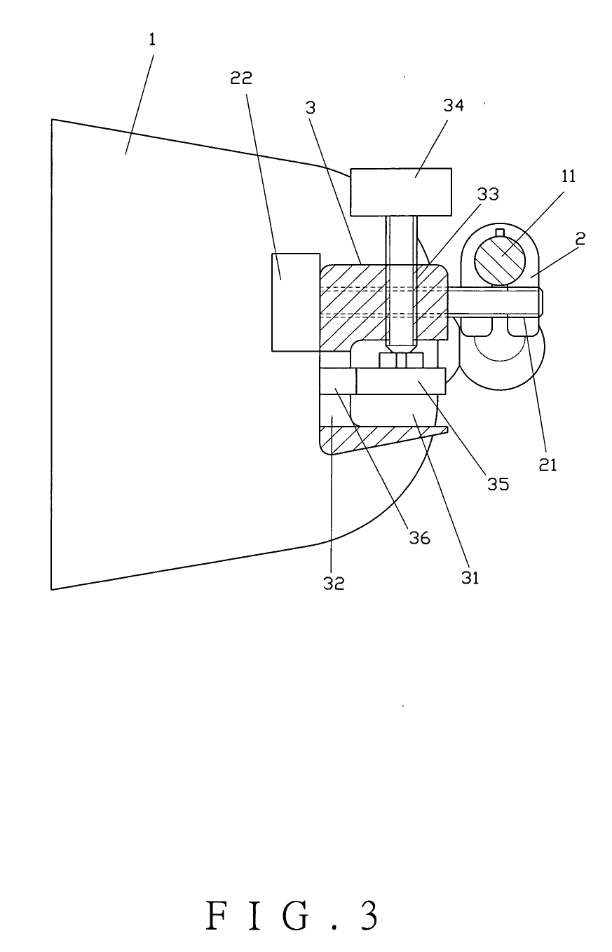

As shown in FIGS. 1-3, a preferred embodiment of the present invention comprises a mirror base 1, a first clipping member 2, and a second clipping member 3.

The mirror base 1 comprises a reflective mirror 12 and an elongated support arm 11. The mirror base 1 is pivotally connected to the support arm 11. The reflective mirror 12 is provided on the mirror base 1.

The first clipping member 2 is affixed on the support arm 11 of the mirror base 1. The first clipping member 2 has a first through hole 21 which is a threaded hole for engagement of a first fastener 22. The first fastener 22 is a screw bolt.

The second clipping member 3 is inserted by the first fastener 22 to fix on the first clipping member 2. The second clipping member 3 has a clipping cavity 31 therein, a limiting slot 32 thereon, and a second through hole 33 thereon. The second through hole 33 is a threaded hole for engagement of a second fastener 34. The second fastener 34 is a screw bolt. One end of the second fastener 34 is provided with a tightening member 35. The tightening member 35 is made of rubber substance and has a protruded locating portion 36 that can be right fitted in the limiting slot 32.

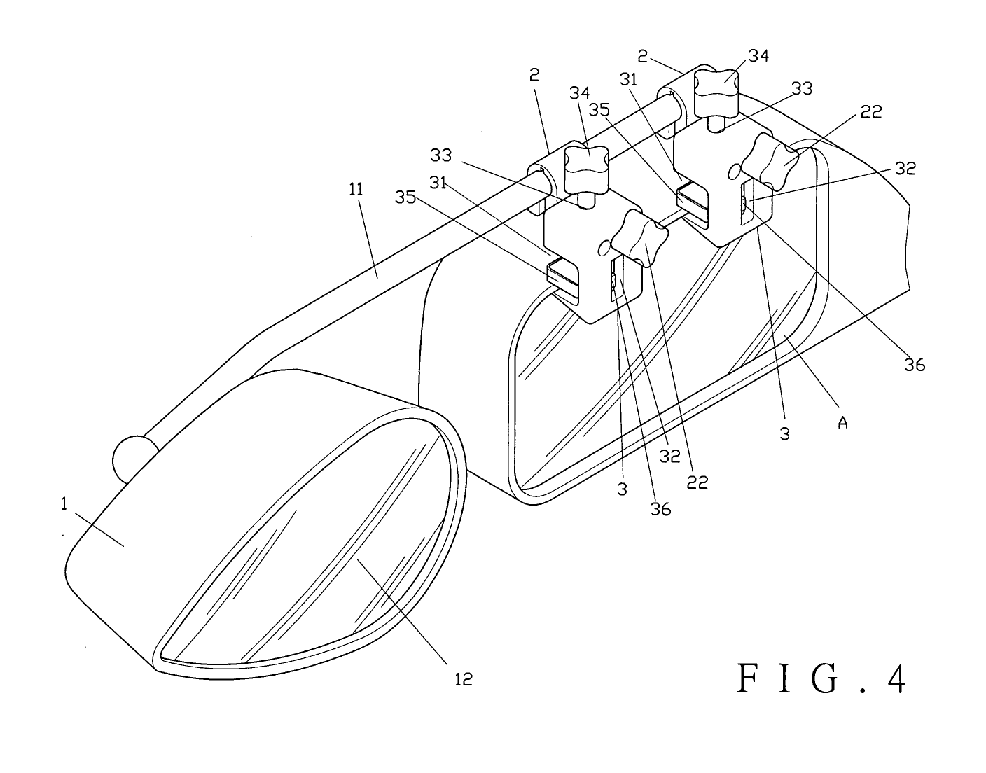

When the present invention is in use, referring to FIGS. 4 & 5, the procedure starts by loosening the second fastener 34 out of the second through hole 33 for at least one set of the second clipping members 3, followed by gripping the rim of a rearview mirror A by means of the clipping cavity 31 in the second clipping member 3, and by tightening the second fastener 34 through the use of the tightening member 35 at one end of the second fastener 34, wherein the locating portion 36 of the tightening member 35 slides down along the limiting slot 32, which enables the pressing of the tightening member 35 directly down to the rearview mirror A that helps to hold firmly the rim of the rearview mirror A, further the gripping of the second fastener 34 on the rearview mirror A; since the tightening member 35 is made of rubber substance, the moment the tightening member 35 grips the rim of the rearview mirror A, it won't hurt the surface of the rearview mirror A, which makes the assembly for the mirror base 1 and the rearview mirror much more handy and solid.

During the demands for adjusting the angle of the mirror base 1 for having an improved rearward visibility, the first fastener 22 is being loosened to enable the first clipping member 2 pivoted on the support arm 11 changing from tight fastening into a mutual rotating, followed by adjusting an arbitrary rotation on the first clipping member 2 or the support arm 11 into the expected angle; for the mirror base 1 is pivotally connected to the support arm 11, an adjustment for rotating the mirror base 1 to come to the best viewing angle, which enables the exposure of the blind zones to the vehicle operator during driving.

As the first fastener 22 of the present invention is being loosening, the first clipping member 2 pivotally connected to the support arm 11 can be adjusted its relative distance along the support arm 11, which will be available for gripping on the rearview mirror of the truck, trailer, vehicle with a hitched trailer or large vehicle, and these are the embodiments of the gripping of the present invention.

What is claimed is:

1. A trailer rearview mirror assembly, comprising:
a mirror base, having a support arm extended thereon;
a first clipping member, affixed on said support arm of said mirror base, said first clipping member having a first through hole for insertion of a first fastener; and
a second clipping member, inserted by said first fastener to fix on said first clipping member, said second clipping member having a clipping cavity therein and a second through hole for insertion a second fastener.

2. The trailer rearview mirror assembly of claim 1, wherein said mirror base is provided with a reflective mirror.

3. The trailer rearview mirror assembly of claim 1, wherein said mirror base is pivotally connected to said support arm.

4. The trailer rearview mirror assembly of claim 1, wherein said first through hole is a threaded hole and said first fastener is a screw bolt.

5. The trailer rearview mirror assembly of claim 1, wherein the second fastener is a screw bolt and the second fastener is provided with a tightening member.

6. The trailer rearview mirror assembly of claim 5, wherein the tightening member is provided with a locating portion.

7. The trailer rearview mirror assembly of claim 6, wherein the second clipping member is provided with a limiting slot for insertion of said locating portion of said tightening member.
